(19) United States
(12) Patent Application Publication
(10) Pub. No.: US 2023/0080383 A1
(43) Pub. Date: Mar. 16, 2023

(54) MOTOR CONTROLLER

(71) Applicant: Global Mixed-mode Technology Inc., Hsin-Chu (TW)

(72) Inventor: Chia-Tai Yang, Hsinchu County (TW)

(73) Assignee: Global Mixed-mode Technology Inc., Hsin-Chu (TW)

(21) Appl. No.: 17/476,498

(22) Filed: Sep. 16, 2021

(51) Int. Cl. H02P 7/29

(52) U.S. Cl. CPC H02P 7/29

(57) ABSTRACT

A motor controller comprises a switch circuit and a control unit. The switch circuit is coupled to a motor for driving the motor. The control unit is configured to generate a plurality of control signals to control the switch circuit. The motor controller utilizes a duty cycle conversion mechanism, such that the motor controller is operated in a constant voltage driving mode or a constant current driving mode. The motor controller is configured to avoid generating switching noise by the constant voltage driving mode or the constant current driving mode. The motor controller is configured to increase a success rate of starting the motor.

### BACKGROUND OF THE INVENTION

### 1. Field of the Invention

The present invention relates to a motor controller, and more particularly, to a motor controller which may be applied to a fan motor system.

### 2. Description of the Prior Art

Conventionally, there are two driving methods for driving a motor. The first driving method uses the Hall sensor for switching phases, so as to drive the motor. The second driving method does not use the Hall sensor to drive the motor. The Hall sensor is affected by the external environment easily, such that the detecting accuracy is decreased. Besides, the installation of the Hall sensor results in an increase of the volume and the cost of the system. Therefore, the sensorless driving method is provided for solving the above problems.

In the sensorless driving method, the motor controller may switch phases by detecting a back electromotive force of a floating phase or a phase current. In general, the motor controller outputs a pulse width modulation signal to control the speed of the motor. However, when the motor controller is in a pulse with modulation driving mode, the output terminal of the motor controller generates switching noise. Such switching noise may result in misjudgment when detecting the voltage or the current, such that the motor is operated abnormally. Thus, a new technology is needed to overcome the drawback of the prior art.

### SUMMARY OF THE INVENTION

According to the present invention, a motor controller which may be applied to a fan motor system is provided. The motor controller comprises a switch circuit, a control unit, and a pulse width modulation processing unit. The switch circuit includes a first transistor, a second transistor, a third transistor, a fourth transistor, a first terminal, and a second terminal. The switch circuit is coupled to a motor for driving the motor. The control unit is configured to generate a plurality of control signals to control the switch circuit. The pulse width modulation processing unit is configured to generate a first pulse width modulation signal to the control unit based on a second pulse width modulation signal, where the first pulse width modulation signal has a first duty cycle and the second pulse width modulation signal has a second duty cycle. The pulse width modulation processing unit may utilize a duty cycle graph or a duty cycle table for generating the first pulse width modulation signal. When the second duty cycle increases, the first duty cycle increases.

The motor controller may adopt a constant voltage driving mode or a constant current driving mode to drive the motor. More specifically, the motor controller may utilize a duty cycle conversion mechanism, such that the motor controller is operated in the constant voltage driving mode or the constant current driving mode, where the control unit may be configured to execute the duty cycle conversion mechanism. When the motor controller is in the constant voltage driving mode and the first duty cycle of the first pulse width modulation signal increases, a constant voltage outputted by the motor controller increases. The constant voltage may be equal to the voltage difference between the first terminal and the second terminal. Furthermore, the constant voltage may be proportional to the first duty cycle. For example, the constant voltage may be equal to the first duty cycle multiplied by an input voltage. At this moment the motor controller may maintain the original output energy and eliminate switching noise at the same time. When the input voltage changes, the motor controller may keep the output energy unchanged by a modulation mechanism. Similarly, when the motor controller is in the constant current driving mode and the first duty cycle increases, a constant current outputted by the motor controller increases. The constant current may be equal to the current flowing through the first terminal and the second terminal. The constant current may be proportional to the first duty cycle. The motor controller is configured to increase a success rate of starting the motor by the constant voltage driving mode or the constant current driving mode.

According to one embodiment of the present invention, the motor controller may utilize a duty cycle conversion mechanism, such that the motor controller is operated in a non pulse width modulation driving mode. The motor controller may utilize the non pulse width modulation driving mode to drive the motor when operating in a start state, a soft start state, or a normal operation state. The motor controller may utilize a pulse width modulation driving mode to drive the motor when operating in a normal operation state. Furthermore, the motor controller is configured to increase a success rate of starting the motor by the non pulse width modulation driving mode. By means of the non pulse width modulation driving mode, the motor controller may avoid generating switching noise, so as to overcome the drawback of the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and the accompanying drawing, wherein:

FIG. 1 is a schematic diagram showing a motor controller according to one embodiment of the present invention.

### DETAILED DESCRIPTION

Preferred embodiments according to the present invention will be described in detail with reference to the drawing.

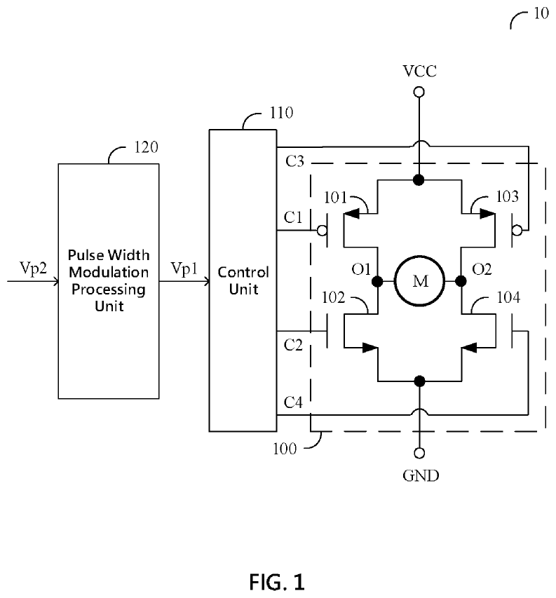

FIG. 1 is a schematic diagram showing a motor controller 10 according to one embodiment of the present invention. The motor controller 10 comprises a switch circuit 100, a control unit 110, and a pulse width modulation processing unit 120. The switch circuit 100 includes a first transistor 101, a second transistor 102, a third transistor 103, a fourth transistor 104, a first terminal O1, and a second terminal O2 for driving a motor M. The motor M is coupled to the first terminal O1 and the second terminal O2. The first transistor 101 is coupled to the first terminal O1 and a third terminal VCC while the second transistor 102 is coupled to the first terminal O1 and a fourth terminal GND. The third transistor 103 is coupled to the second terminal O2 and the third terminal VCC while the fourth transistor 104 is coupled to the second terminal O2 and the fourth terminal GND. The third terminal VCC has an input voltage, where the input voltage may be a power supply voltage. Each of the first transistor 101, the second transistor 102, the third transistor 103, and the fourth transistor 104 may be respectively a p-type MOSFET or an n-type MOSFET. As shown in FIG. 1, each of the first transistor 101 and the third transistor 103 may be a p-type MOSFET, while each of the second transistor 102 and the fourth transistor 104 may be an n-type MOSFET. The control unit 110 generates a first control signal C1, a second control signal C2, a third control signal C3, and a fourth control signal C4 so as to respectively control the ON/OFF states of the first transistor 101, the second transistor 102, the third transistor 103, and the fourth transistor 104. The control unit 110 receives a first pulse width modulation signal Vp1 to control the switch circuit 100, where the first pulse width modulation signal Vp1 has a first duty cycle. The first pulse width modulation signal Vp1 may be an output pulse width modulation signal. The pulse width modulation processing unit 120 is configured to generate the first pulse width modulation signal Vp1 to the control unit 110 based on a second pulse width modulation signal Vp2, where the second pulse width modulation signal Vp2 has a second duty cycle. The second pulse width modulation signal Vp2 may be an input pulse width modulation signal. The pulse width modulation processing unit 120 may utilize a duty cycle graph or a duty cycle table for generating the first pulse width modulation signal Vp1. When the second duty cycle increases, the first duty cycle increases. Moreover, the motor controller 10 may be applied to a fan motor system, such that a fan is capable of operating normally.

The control unit 110 may operate alternatively in a first driving mode and a second driving mode, so as to supply the electric energy to the motor M. In the first driving mode, the control unit 110 turns on the first transistor 101 and the fourth transistor 104 by controlling the first control signal C1 and the fourth control signal C4. At this moment the current flows sequentially from the third terminal VCC to the first transistor 101, the motor M, and the fourth transistor 104 for supplying the electric energy to the motor M. In the second driving mode, the control unit 110 turns on the second transistor 102 and the third transistor 103 by controlling the second control signal C2 and the third control signal C3. At this moment the current flows sequentially from the third terminal VCC to the third transistor 103, the motor M, and the second transistor 102 for supplying the electric energy to the motor M. By operating alternatively between the first driving mode and the second driving mode, the motor M can be operated normally as a result.

The motor controller 10 may adopt a constant voltage driving mode or a constant current driving mode to drive the motor M. By means of the constant voltage driving mode or the constant current driving mode, the motor controller 10 may avoid generating switching noise, thereby overcoming the drawback of the prior art. More specifically, the motor controller 10 may utilize a duty cycle conversion mechanism, such that the motor controller 10 is operated in the constant voltage driving mode or the constant current driving mode, where the control unit 110 may be configured to execute the duty cycle conversion mechanism. When the motor controller 10 is in the constant voltage driving mode and the first duty cycle of the first pulse width modulation signal Vp1 increases, a constant voltage outputted by the motor controller 10 increases. The constant voltage may be equal to the voltage difference between the first terminal O1 and the second terminal O2. Furthermore, the constant voltage may be proportional to the first duty cycle. For example, the constant voltage may be equal to the first duty cycle multiplied by the input voltage. That is to say, when the first duty cycle is 50%, the constant voltage is one half of the input voltage. At this moment the motor controller 10 may maintain the original output energy and eliminate switching noise at the same time. When the input voltage changes, the motor controller 10 may keep the output energy unchanged by a modulation mechanism. Similarly, when the motor controller 10 is in the constant current driving mode and the first duty cycle increases, a constant current outputted by the motor controller 10 increases. The constant current may be equal to the current flowing through the first terminal O1 and the second terminal O2. The constant current may be proportional to the first duty cycle. The designer may adopt the constant voltage driving mode or the constant current driving mode to drive the motor M based on different applications. According to one embodiment of the present invention, the motor controller 10 may utilize a non pulse width modulation driving mode to control the switch circuit 100 for outputting a specific energy, so as to enable the motor M to be operated normally and eliminate switching noise simultaneously. By means of the non pulse width modulation driving mode, the motor controller 10 may be configured to increase a success rate of starting the motor M. Moreover, the motor controller 10 may be applied to a single-phase or polyphase configuration. The motor controller 10 may switch phases by detecting a back electromotive force of a floating phase or a phase current.

Since the back electromotive force may be too small in a starting procedure, the motor controller 10 may utilize the constant voltage driving mode or the constant current driving mode to drive the motor M when operating in a start state, thereby avoiding misjudging a phase switching time point. That is, the motor controller may utilize the non pulse width modulation driving mode to drive the motor M when operating in the start state. When the motor controller 10 is in a normal operation state and the first duty cycle is too small, the motor controller 10 may utilize the constant voltage driving mode or the constant current driving mode to drive the motor M, thereby avoiding misjudging a phase switching time point. Therefore, when the motor controller 10 is in the normal operation state, the designer may utilize the constant voltage driving mode, the constant current driving mode, or a pulse width modulation driving mode to drive the motor M based on different operating conditions or applications. Moreover, the motor controller 10 may utilize the constant voltage driving mode or the constant current driving mode to drive the motor M when operating in a soft start state. That is, the motor controller 10 may utilize the non pulse width modulation driving mode to drive the motor M when operating in the soft start state.

According to one embodiment of the present invention, the motor controller 10 may be applied to a sensorless motor system, a DC motor system, and a brushless motor system. The motor controller 10 utilizes a duty cycle conversion mechanism, such that the motor controller 10 is operated in a constant voltage driving mode or a constant current driving mode, thereby increasing a success rate of starting the motor M. The motor controller 10 drives the motor M by a non pulse width modulation driving mode, so as to overcome the drawback of the prior art. The motor controller 10 may be operated in the non pulse width modulation driving mode based on a duty cycle conversion mechanism.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor controller, comprising:
a switch circuit, coupled to a motor for driving the motor; and
a control unit, configured to generate a plurality of control signals to control the switch circuit, wherein the motor controller utilizes a duty cycle conversion mechanism, such that the motor controller is operated in a constant voltage driving mode or a constant current driving mode.

2. The motor controller of claim 1, wherein the motor controller is applied to a sensorless motor system.

3. The motor controller of claim 1, wherein the motor controller is configured to avoid generating switching noise by the constant voltage driving mode or the constant current driving mode.

4. The motor controller of claim 1, wherein the control unit is configured to execute the duty cycle conversion mechanism.

5. The motor controller of claim 1, wherein the motor controller is configured to increase a success rate of starting the motor by the constant voltage driving mode or the constant current driving mode.

6. The motor controller of claim 1, wherein the switch circuit comprises a first terminal and a second terminal, and when the motor controller is in the constant voltage driving mode, a constant voltage outputted by the motor controller is equal to a voltage difference between the first terminal and the second terminal.

7. The motor controller of claim 1, wherein the switch circuit comprises a first terminal and a second terminal, and when the motor controller is in the constant current driving mode, a constant current outputted by the motor controller is equal to a current flowing through the first terminal and the second terminal.

8. The motor controller of claim 1, wherein the control unit receives a first pulse width modulation signal to control the switch circuit, wherein the first pulse width modulation signal has a first duty cycle.

9. The motor controller of claim 8, wherein when the motor controller is in the constant voltage driving mode and the first duty cycle increases, a constant voltage outputted by the motor controller increases.

10. The motor controller of claim 9, wherein the constant voltage is proportional to the first duty cycle.

11. The motor controller of claim 9, wherein the constant voltage is equal to the first duty cycle multiplied by an input voltage.

12. The motor controller of claim 11, wherein the input voltage is a power supply voltage.

13. The motor controller of claim 8, wherein when the motor controller is in the constant current driving mode and the first duty cycle increases, a constant current outputted by the motor controller increases.

14. The motor controller of claim 13, wherein the constant current is proportional to the first duty cycle.

15. The motor controller of claim 1, wherein when an input voltage changes, the motor controller keeps an output energy unchanged by a modulation mechanism.

16. The motor controller of claim 1, wherein the motor controller is applied to a single-phase or polyphase configuration.

17. The motor controller of claim 1, wherein the motor controller utilizes the constant voltage driving mode to drive the motor when operating in a start state.

18. The motor controller of claim 1, wherein the motor controller utilizes the constant current driving mode to drive the motor when operating in a start state.

19. The motor controller of claim 1, wherein the motor controller utilizes the constant voltage driving mode to drive the motor when operating in a soft start state.

20. The motor controller of claim 1, wherein the motor controller utilizes the constant current driving mode to drive the motor when operating in a soft start state.

21. The motor controller of claim 1, wherein the motor controller utilizes the constant voltage driving mode to drive the motor when operating in a normal operation state.

22. The motor controller of claim 1, wherein the motor controller utilizes the constant current driving mode to drive the motor when operating in a normal operation state.

23. The motor controller of claim 1, wherein the motor controller utilizes a pulse width modulation driving mode to drive the motor when operating in a normal operation state.

24. The motor controller of claim 1, wherein the switch circuit comprises:
a first transistor, coupled to a first terminal and a third terminal;
a second transistor, coupled to the first terminal and a fourth terminal;
a third transistor, coupled to a second terminal and the third terminal; and
a fourth transistor, coupled to the second terminal and the fourth terminal.

25. The motor controller of claim 1, wherein the motor controller further comprises a pulse width modulation processing unit, the pulse width modulation processing unit is configured to generate a first pulse width modulation signal to the control unit based on a second pulse width modulation signal, the first pulse width modulation signal has a first duty cycle, and the second pulse width modulation signal has a second duty cycle.

26. The motor controller of claim 25, wherein the pulse width modulation processing unit utilizes a duty cycle graph to generate the first pulse width modulation signal.

27. The motor controller of claim 25, wherein the pulse width modulation processing unit utilizes a duty cycle table to generate the first pulse width modulation signal.

28. The motor controller of claim 25, wherein when the second duty cycle increases, the first duty cycle increases.

29. The motor controller of claim 1, wherein the motor controller is applied to a fan motor system.

30. The motor controller of claim 1, wherein the motor controller is applied to a DC motor system.

31. The motor controller of claim 1, wherein the motor controller is applied to a brushless motor system.

32. The motor controller of claim 1, wherein the motor controller switches phases by detecting a back electromotive force of a floating phase.

33. The motor controller of claim 1, wherein the motor controller switches phases by detecting a phase current.

34. A motor controller, comprising:
a switch circuit, coupled to a motor for driving the motor; and
a control unit, configured to generate a plurality of control signals to control the switch circuit, wherein the motor controller utilizes a duty cycle conversion mechanism, such that the motor controller is operated in a constant voltage driving mode.

35. The motor controller of claim 34, wherein the motor controller is applied to a sensorless motor system.

36. The motor controller of claim 34, wherein the motor controller utilizes the constant voltage driving mode to drive the motor when operating in a start state.

37. The motor controller of claim 34, wherein the motor controller utilizes the constant voltage driving mode to drive the motor when operating in a soft start state.

38. The motor controller of claim 34, wherein the motor controller utilizes the constant voltage driving mode to drive the motor when operating in a normal operation state.

39. A motor controller, comprising:
a switch circuit, coupled to a motor for driving the motor; and
a control unit, configured to generate a plurality of control signals to control the switch circuit, wherein the motor controller utilizes a duty cycle conversion mechanism, such that the motor controller is operated in a constant current driving mode.

40. The motor controller of claim 39, wherein the motor controller is applied to a sensorless motor system.

41. The motor controller of claim 39, wherein the motor controller utilizes the constant current driving mode to drive the motor when operating in a start state.

42. The motor controller of claim 39, wherein the motor controller utilizes the constant current driving mode to drive the motor when operating in a soft start state.

43. The motor controller of claim 39, wherein the motor controller utilizes the constant current driving mode to drive the motor when operating in a normal operation state.

44. A motor controller, comprising:
a switch circuit, coupled to a motor for driving the motor; and
a control unit, configured to generate a plurality of control signals to control the switch circuit, wherein the motor controller utilizes a duty cycle conversion mechanism, such that the motor controller is operated in a non pulse width modulation driving mode.

45. The motor controller of claim 44, wherein the motor controller is applied to a sensorless motor system.

46. The motor controller of claim 44, wherein the motor controller utilizes the non pulse width modulation driving mode to drive the motor when operating in a start state.

47. The motor controller of claim 44, wherein the motor controller utilizes the non pulse width modulation driving mode to drive the motor when operating in a soft start state.

48. The motor controller of claim 44, wherein the motor controller utilizes the non pulse width modulation driving mode to drive the motor when operating in a normal operation state.
